(19) United States
(12) Patent Application Publication
(10) Pub. No.: US 2018/0241716 A1
(43) Pub. Date: Aug. 23, 2018

(54) METHODS AND APPARATUSES FOR PROVIDING ADDRESSABILITY TO DEVICES IN A NETWORK

(71) Applicant: THOMSON Licensing, Issy-Les-Moulineaux (FR)

(72) Inventor: Harold Gene ROBERTS, Carmel, IN (US)

(21) Appl. No.: 15/751,894

(22) PCT Filed: Jul. 28, 2016
(86) PCT No.: PCT/US2016/044471

§ 371 Date: Feb. 12, 2018

Related U.S. Application Data
(60) Provisional application No. 62/206,473, filed on Aug. 18, 2015.

(51) Int. Cl. H04L 29/12; H04L 12/28

(52) U.S. Cl. CPC H04L 61/2007; H04L 61/6059; H04L 41/046; H04L 61/106; H04L 12/2801; H04L 61/2092

(57) ABSTRACT

The present disclosure is directed to apparatuses and methods for providing network addressability for one or more logical entities associated with a communication interface of a tangible device in a network. In one aspect of the present disclosure, a media access control address of a communication interface is converted to an Internet protocol address for a logical entity associated with the communication interface. When the apparatuses and methods of the present disclosure receive a communication signal including the converted Internet protocol address, the communication signal is provided to the logical entity associated with the Internet protocol address. In another aspect of the present disclosure, a user input received at a communication interface is mapped to an Internet protocol address to send a request to a logical entity.

### REFERENCE TO RELATED PROVISIONAL APPLICATION

This application claims priority from U.S. Provisional Application No. 62/206,473, entitled “Method and Apparatus for Providing Addressability to Devices in a Network,” filed on Aug. 18, 2015, the contents of which are hereby incorporated by reference in its entirety.

### TECHNICAL FIELD

The present disclosure generally relates to communication systems, and more particularly, to methods and apparatuses for addressing one or more logical entities associated with a communication device.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Today, modems, such as cable modems, offer Internet connectivity to subscribers' homes. These modems are typically connected to an information distribution network, such as a coaxial cable network, an optical fiber network, a hybrid fiber/coaxial cable network, or a wireless network, and communicate with a network device outside the home (e.g., a termination system, such as a headend or cable modem termination server (CMTS)). Within the home, the modem may be connected to an in-home network or local area network (LAN), such as an Ethernet network, an in-home coaxial cable network (e.g., per the Multimedia over Coax Alliance (MoCA) specification), wireless network, etc., and various devices within the home may use that local area network to ultimately communicate with network devices outside the home. Additionally, the modem may provide telephone services to the home (e.g., Voice over IP (VoIP) services). Such multi-function modems are commonly referred to as a gateway or gateway device.

The communication protocol used in a cable network between the home device (e.g., cable modem or gateway) and the CMTS is referred to as Data over Cable Service Interface Specification (DOCSIS). The latest protocol that is available today is DOCSIS version 3.1. DOCSIS 3.1 expands use of Internet Protocol communications including capabilities to allow IP version 4 (IPv4) through IPv6.

Most networks provide a defined separation between wide area network (WAN) communications and LAN communications. Typically, LAN protocol signaling is terminated as they enter the WAN. However, it is possible, and perhaps preferable to operate a WAN as if it were a LAN. Several problems may arise when operating a WAN as if it were a LAN. One of the biggest problems is providing proper addressability of a device in a WAN when it is in fact communicating as if it were on a LAN (e.g., using layer 2 components and protocols). Therefore, there is a need for a mechanism to allow device addressability in a network, specifically for operation in a WAN that may also use LAN protocols.

### SUMMARY

In one aspect of the present disclosure a method is provided including: receiving an input from a user at a device, determining if the input was received through a first communication interface coupled to a first local area network, and sending a first request for a first webpage to a first logical entity associated with the first communication interface if it is determined that the input was received through the first communication interface, the first webpage including information associated with the first communication interface.

In another aspect of the present disclosure an apparatus is provided including a first communication interface coupled to a first local area network, and a processor coupled to the first communication interface, wherein the processor receives an input from a user, the input representing an indirect identification of a uniform resource locator, determines if the input was received through the first communication interface, and sends a first request for a first webpage to a first logical entity associated with the first communication interface if it is determined that the input was received through the first communication interface, the first webpage including information associated with the first communication interface.

### BRIEF DESCRIPTION OF THE DRAWINGS

These, and other aspects, features and advantages of the present disclosure will be described or become apparent from the following description of the embodiments, which is to be read in connection with the accompanying drawings.

In the drawings, wherein like reference numerals denote similar elements throughout the views:

FIG. 1 is a block diagram of a networking communication system in accordance with an embodiment of the present disclosure;

FIG. 2 is a block diagram of a gateway system in accordance with an embodiment of the present disclosure;

FIG. 3 is a block diagram of an exemplary gateway device in accordance with an embodiment of the present disclosure;

FIG. 4 is a block diagram of an exemplary network termination device in accordance with an embodiment of the present disclosure;

FIG. 5 is a block diagram of another networking communication system in accordance with an embodiment of the present disclosure;

FIG. 6 is a flowchart of an exemplary method for creating an IPv6 address for a logical entity and receiving communication signals addressing the IPv6 address for the logical entity in accordance with an embodiment of the present disclosure; and

FIG. 7 is a flowchart of an exemplary method for requesting a web page from a logical entity associated with a communication interface in accordance with an embodiment of the present disclosure.

It should be understood that the drawing(s) is for purposes of illustrating the concepts of the disclosure and is not necessarily the only possible configuration for illustrating the disclosure.

### DETAILED DESCRIPTION

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, a System on a Chip (SoC), digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the embodiments hereof, any element expressed or described as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The present disclosure is directed to apparatuses and methods for providing network addressability for a logical concept or entity, such as a user interface, associated with a tangible device in a network. Some examples of a logical concept or entity associated with a device are 1) web pages containing information associated with a specific Ethernet port; 2) a maintenance entity group (MEG) end point (MEP) to collect and provide connectivity fault management for operations, administration, and maintenance associated with a specific Ethernet port; or 3) a MEG intermediate point (MIP) to collect and provide connectivity fault management for operations, administration, and maintenance associated with a specific Ethernet port. The embodiments described below address problems with network configuration and addressability of devices that operate in a WAN but may use layer 2 protocols. In particular, the embodiments address how to allow logical device addressability in an IPv6 WAN using layer 2 communication protocols. The embodiments use port identification and further provide specific identification and address compatibility/conversion for the port identification. Further, an embodiment describing a convenient mechanism that enables a user to use the adapted address for the logical device using the layer 2 protocols without having to learn or understand any specific information about the adapted address is provided.

The present embodiments provide a solution to addressability issues as they relate to a DOCSIS cable network operating as a WAN. It is important to note that other networks, such as a phone line DSL, optical, or wireless networks that operate as a WAN may also use Internet protocols including, but not limited to IPv6 protocols, and may also permit “private” communication pipes between content providers on a shared WAN and user devices on a private LAN. As such, the present embodiments may be easily modified by one skilled art to work in these other networks. For example, specific embodiments below are described in relate to IPv6 version of Internet protocol. Aspects of the present embodiments may be applied to an Internet protocol version created and/or used with a version number higher than, or after, IPv6.

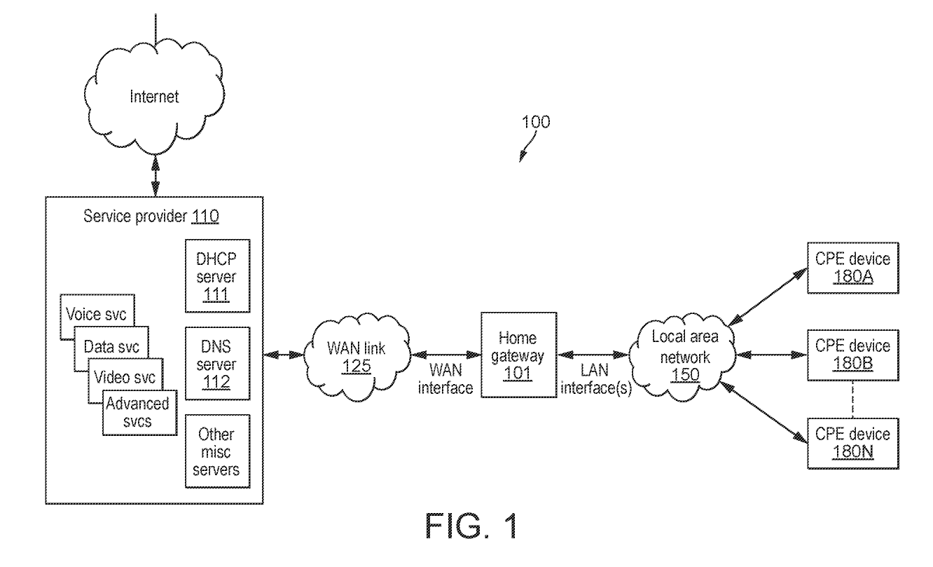

Turning to FIG. 1, a block diagram of a typical arrangement for a networking communication system 100 according to aspects of the present disclosure is shown. According to an exemplary embodiment, home gateway 101 is an advanced cable gateway, cable modem, DSL modem, fiber modem, fixed wireless modem or the like, and is coupled to a wide area network (WAN) link 125 through a WAN interface to service provider 110. The WAN link 125 may be any one or more of the possible communication links including, but not limited to, coaxial cable, fiber optic cable, telephone line, or over the air links (e.g., wireless). The home gateway 101 is also coupled via a local area network (LAN) interface to home network 150 which couples one or more customer premises equipment (CPE) devices 180A-N. The home network 150 may include wireless link(s) and may also include wired links such as co-axial cable or Ethernet. CPE devices 180A-N may include, for example, personal computers, network printers, digital set-top boxes, and/or audio/visual media servers and players, among others.

Service provider 110 provides one or more services, such as voice, data, video and/or various advanced services, over WAN link 125 to CPE devices 180A-N through home gateway 101 and LAN interface 150. Service provider 110 may include Internet-related services and server structures such as a DHCP server 111 and DNS server 112, and may include other servers and services as well (e.g., video on demand, news, weather). It is important to note that these servers and services can be co-located or widely distributed, physically and/or virtually, in both hardware and software. It is contemplated that service provider 110 operates in a conventional manner in accordance with well known protocols (e.g., DOCSIS). In an illustrative cable application, service provider 110 may be, for example, a cable multiple service operator (MSO).

Home gateway 101 acts as the interface between the WAN link 125 external to the customer's home and the home network 150 located in the customer's home. Home gateway 101 converts transport data frames/packets, such as packets in an IP protocol, from a format used in the WAN to a format used in the home network or LAN. Home gateway 101 also routes data frames/packets, including the converted data frames/packets between the WAN and one or more devices on the home network. Home gateway 101 allows data, voice, video and audio communication between the WAN and CPE devices 180A-N used in the customer's home, such as analog telephones, televisions, computers, and the like.

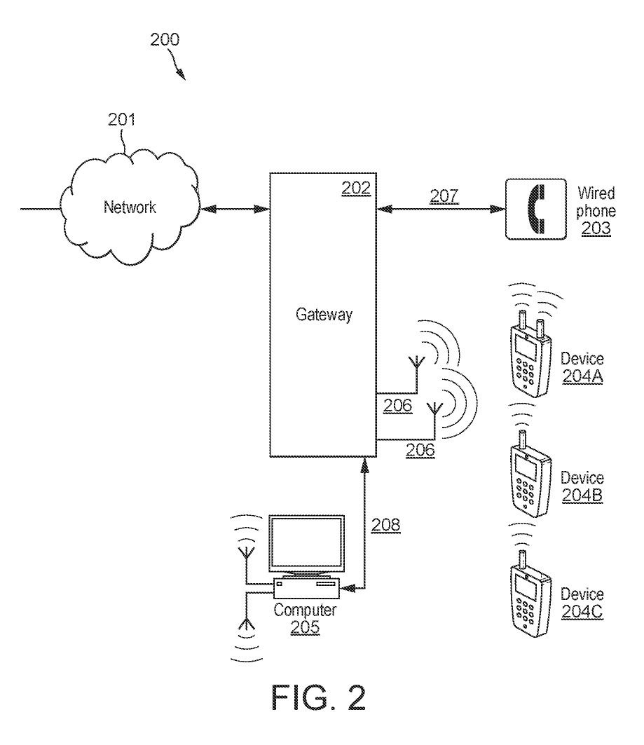

In some embodiments, the functions of the home gateway 101 may be split between two devices. The first device referred to as a network termination device (NTD), such as a cable modem, may include the communication and modem functions found in gateway 101 for interfacing to the WAN. The NTD provides a connection into the WAN as well as an interface to a second device, referred to as a home server, a home router, or home gateway, for communication in the home network or LAN. Separating the functionality as described allows the network service provider to control the operation of the NTD while the consumer or home user is free to purchase any home device for use from a variety of different content service providers, sometimes referred to as access seekers, independent of the WAN that is used. It is important to note that a full gateway device, such as gateway 101, may also be described as including two functional operational components representing the two devices described herein. The descriptions of FIGS. 2 to 4 below may further include descriptions that apply equally to either a full gateway device or a combination of an NTD and a home server, router, or gateway.

It is important to note that the NTD, although connected to a WAN and providing an interface to the home gateway as part of the home LAN, may be required to operate in the service provider's network portion of the WAN using the layer 2 protocols. Usually, NTDs or modems provide layer 3 communication protocols for WAN use to the gateway and reserves layer 2 protocols for the LAN-style communications on the WAN side of the network. As one example, in addition to having a global/universal media access control MAC Address for a network interface, the NTD or modem may include private or “local” MAC addresses for use in the LAN. However, these private addresses will not usually propagate through the WAN based on the communication protocols as they can cause problems with MAC address registries and authentications. The present disclosure provides techniques that enable an NTD or modem to communicate into a WAN using layer 2 protocols while maintaining its private MAC addresses and further providing a proper MAC address structure for the WAN.

FIG. 2 shows a gateway system 200 according to aspects of the present disclosure. Gateway system 200 operates in a manner similar to home gateway 101 described in FIG. 1. In gateway system 200, network 201 is coupled to gateway 202. Gateway 202 connects to wired phone 203. Gateway 202 also connects to computer 205. In addition, gateway 202 interfaces with devices 204A-204C through a wireless interface using one or more antennas 206. Gateway 202 may also interface with computer 205 using one or more antennas 206.

In particular, gateway system 200 operates as part of a cable network interface and acts to interface a data cable system to one or more home networks. Gateway system 200 includes a gateway 202 that provides the interface between the network 201, operating as a WAN, and the home network(s). Gateway system 200 also includes wired analog telephone device 203 capable of operating as a home telephone when connected through gateway 202 via a wired connection 207. In addition, gateway 202 also acts to provide a radio frequency (RF) interface to multiple wireless devices 204A, 204B, and 204C. Wireless devices 204A, 204B, and 204C are handheld devices that use wireless packet transmissions via one or more antennas 206 on gateway 202. In other embodiments, other devices with wireless interfaces including, but not limited to routers, tablets, settop boxes, televisions, and media players may be used.

The wireless interface included in gateway 202 may also accommodate one or more wireless formats including Wi-Fi, Institute of Electrical and Electronics Engineers standard IEEE 802.11 or other similar wireless communication protocols. Further, it is important to note that each antenna in the system may be attached to a separate transceiver circuit. As shown in FIG. 2, gateway 202 includes two transceiver circuits and two antennas. Device 204A and computer 205 also include two transceiver circuits and two antennas while device 204B and device 204C include only one transmit receive circuit and one antenna. In some alternate designs, it may be possible that more than one antenna may be included with, and used by, a single transceiver circuit.

In operation, gateway 202 provides Internet protocol (IP) services (e.g., data, voice, video, and/or audio) between devices 204A-C and Internet destinations identified and connected via network 201. Gateway 202 also provides IP voice services between wired phone 203 and call destinations routed through network 201. Gateway 202 further provides connectivity to a local computer 205 either via a wired connection 208 such as is shown in FIG. 2 or via a wireless connection through one or more antennas and transceiver circuits 206. Thus, exemplary interfaces for computer 205 include Ethernet and IEEE 802.11. As noted above, gateway 202 may physically be configured as two components, a cable modem or NTD that connects to network 201 and a home gateway that connects to all other devices in the home.

Gateway 202 further includes a communication front end circuit for interfacing with the head end or CMTS through the network 201. In some embodiments, the gateway 202 further includes circuitry for communicating in the home network or LAN using MoCA protocols over co-axial cable. The communication front end circuit includes a diplexer filter or a triplexer filter if MoCA is included, for separating the upstream communication and downstream communication signals (as well as MoCA signals if present). Further, the embodiment described here primarily is used in a cable system, and more particularly is used in a system using DOCSIS 3.1 protocols. It is likely that the present embodiments may also be useful in future advancement of the cable data protocols. As such, the present embodiments may be primarily used in a cable modem device or a gateway that employ data modem functionality. However, other devices that include data modem or any other form of two communication functionality may also include the aspects of the present embodiments.

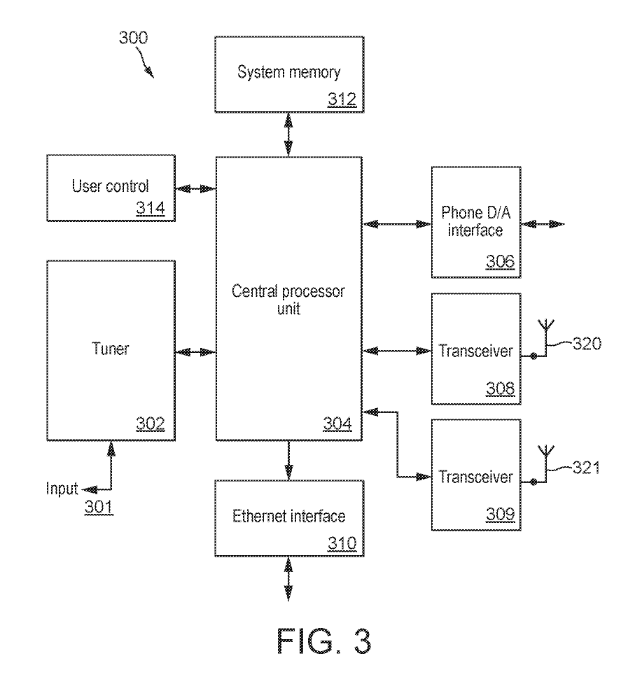

Turning to FIG. 3, a block diagram of an exemplary gateway device 300 according to aspects of the present disclosure is shown. Gateway device 300 may correspond to gateway 202 described in FIG. 2 or to home gateway 101 described in FIG. 1. In gateway device 300, an input signal is provided to RF input 301. RF input 301 connects to tuner 302. Tuner 302 connects to central processor unit 304. Central processor unit 304 connects to phone D/A interface 306, transceiver 308, transceiver 309, Ethernet interface 310, system memory 312, and user control 314. Transceiver 308 further connects to antenna 320. Transceiver 309 further connects to antenna 321. It is important to note that several components and interconnections necessary for complete operation of gateway device 300 are not shown in the interest of conciseness, as the components not shown are well known to those skilled in the art. Gateway device 300 may be capable of operating as an interface to a cable or DSL communication network and further may be capable of providing an interface to one or more devices connected through either a wired and wireless home network.

A signal, such as a cable or DSL signal on the WAN, is interfaced to tuner 302 through RF input 301. Tuner 302 performs RF modulation functions on a signal provided to the WAN and demodulation functions on a signal received from the WAN. The RF modulation and demodulation functions are the same as those commonly used in communication systems, such as cable or DSL systems. Central processor unit 304 accepts the demodulated cable or DSL signals and digitally processes the signal from tuner 302 to provide voice signals and data for the interfaces in gateway 300. Similarly, central processor unit 304 also processes and directs any voice signals and data received from any of the interfaces in gateway 300 for delivery to tuner 302 and transmission to the WAN.

System memory 312 supports the processing and IP functions in central processor unit 304 and also serves as storage for program and data information. Processed and/or stored digital data from central processor unit 304 is available for transfer to and from Ethernet interface 310. Ethernet interface may support a typical Registered Jack type RJ-45 physical interface connector or other standard interface connector and allow connection to an external local computer. Processed and/or stored digital data from central processor unit 304 is also available for digital to analog conversion in interface 306. Interface 306 allows connection to an analog telephone handset. Typically, this physical connection is provided via an RJ-11 standard interface, but other interface standards may be used. Processed and/or stored digital data from central processor unit 304 is additionally available for exchange with transceiver 308 and transceiver 309. Transceiver 308 and transceiver 309 can both support multiple operations and networked devices simultaneously. Central processor unit 304 is also operative to receive and process user input signals provided via a user control interface 314, which may include a display and/or a user input device such as a hand-held remote control and/or other type of user input device.

As noted above, the gateway device 300 may be configured to operate as an NTD. In this case, central processing unit 304 may only connect to Ethernet interface 310 and system memory 312. Phone digital-to-audio (D/A) interface 306, transceiver 308 and/or transceiver 309 may not be present or used. Further, an NTD may not include a direct end-user or consumer interface and as such may not include user control 314. Additionally, the NTD may include and support more than one Ethernet interface 310 and may be capable of operating each Ethernet interface as a separate virtual circuit between the content service provider(s) and the home gateway attached to the Ethernet interface, thus allowing the creation of separate LANs for each content consumer.

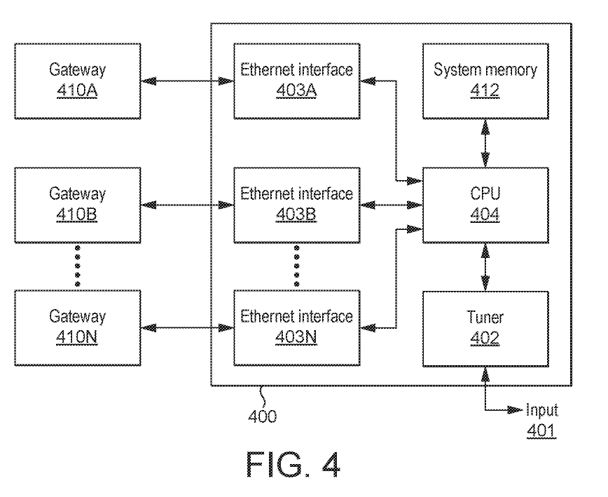

For example, referring to FIG. 4, an NTD 400 coupled to a plurality of home gateways 410 is shown in accordance with an embodiment of the present disclosure. NTD 400 may be a standalone device or may be included in a larger gateway device, such as gateway 101 described in FIG. 1. NTD 400 includes a CPU 404 coupled to system memory 412, tuner 402, and a plurality of interfaces 403 configured to interface NTD 400 to a plurality of home gateways or modems 410, where, in one embodiment, each gateway or modem 410 is part of a separate LAN. In one embodiment, each interface 403 is an Ethernet port of NTD 400. As seen in FIG. 4, each Ethernet interface 403 is coupled to a corresponding home gateway 410. In some embodiments, the NTD 400 may be included with one of the corresponding home gateways 410. NTD 400 is coupled to a WAN via input 401 and tuner 402. It is to be appreciated that in one embodiment, CPU 404, system memory 412, tuner 402 may be the same or similar to CPU 304, system memory 312, and tuner 302.

As stated above, in one embodiment, each gateway 410 may correspond to a separate LAN for each customer being serviced by a service provider providing content or services (e.g., Internet, telephone, television, etc.). For example, downstream signals received via tuner 402 are provided to CPU 404. CPU 404 is configured to bridge frames using a layer 2 virtual LAN address for a gateway or packets using an IP address for a gateway to the proper Ethernet interface 403 associated with the gateway 410. When NTD 400 receives downstream communication signals via a communication interface coupled to the WAN, such as input 401 and tuner 402, CPU 404 is configured to determine, based on the layer 2 virtual LAN address or IP address used in the communication signal, which Ethernet interface 403 to transmit the downstream signals to. In this way, NTD 400 enables a plurality of service providers to provide content to a plurality of LANs, where each LAN may be serviced by a different service provider.

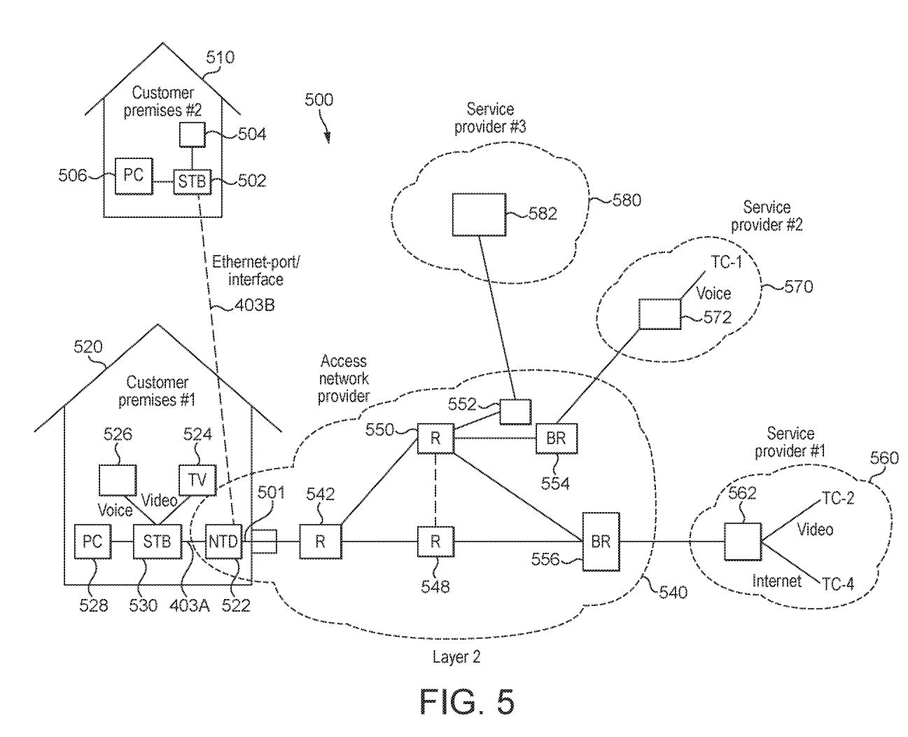

Referring to FIG. 5, an NTD 522 is shown coupled to a WAN in accordance with an embodiment of the present disclosure, where, in one embodiment, NTD 522 is used as a cable modem for a Hybrid-Fiber Co-axial cable (HFC) DOCSIS access network (i.e., a WAN). The operation of NTD 522 may be similar to the operation of NTD 400 described in FIG. 4. As seen in FIG. 5, a plurality of service providers, such as service providers 560, 570, 580, are coupled to an access network provider 540, where the access network provider 540 is coupled to an NTD 522, via WAN interface 501 (i.e., a radio frequency (RF) interface). It is to be appreciated that WAN interface 501 may be the same as input 401 and tuner 402.

It is to be appreciated that each service provider, of the plurality of service providers, may provide one of many different types of services for a user. For example, service provider 560 may provide Internet and television services, while service provider 570 may provide telephone services. It is to be appreciated that each service provider may provide a plurality of services, for example, service provider 580 may provide Internet, television, and telephone services via WAN 500.

Each of the plurality of service providers 560, 570, 580 may lease bandwidth from an access network provider (ANP), such as ANP 540, so that the service provider 560, 570, 580 can service one or more customer premises, such as customer premises 510 and 520. As seen in FIG. 5, service provider 560 includes router 562, service provider 570 includes router 572, and service provider 580 includes router 582, where each of routers 562, 572, and 582 are coupled to CMTS router 542 via one or more routing elements. For example, router 582 is coupled to router 552, router 572 is coupled to router 554, and router 562 is coupled to router 556. Routers 552, 554, and 556 are each coupled to router 550. Router 550 is also coupled to routers 542 and 548. CMTS router 542 is coupled to NTD 522 via interface 500.

Although not shown, it is to be appreciated that many networking elements have been omitted from FIG. 5 for the sake of simplicity. Furthermore, although only three service providers (i.e., 560, 570, and 580) and two customer premises (i.e., 510 and 520) are shown in FIG. 5, it is to be appreciated that the teachings of the present disclosure may be used with any number of service providers coupled to an ANP, such as ANP 540, to service any number of customer premises.

Each communication interface (i.e., Ethernet interfaces 403) of NTD 522 may be coupled to a different gateway or set-top box (such as 502 and 530), where each gateway or set-top box (such as 502 and 530) may be associated with a separate LAN. The NTD 522 of the present disclosure allows for each Ethernet interface 403 of NTD 522 to be individually addressable through the WAN by a service provider, such as service providers 560, 570, and 580. In this way, a plurality of service providers may interface to a plurality of LANs via NTD 522. It is to be appreciated that NTD 522 may be configured to interface to any number of LANs by including additional communication interfaces (i.e., Ethernet interfaces 403) coupled to corresponding home gateways 410 associated with separate LANs.

NTD 522 is coupled to a gateway or set-top box 530 via a first communication interface (e.g., Ethernet interface 403A) of NTD 522. It is to be appreciated that a service provider, such as service provider 560, may service the customer in premises 520. To service the customer in customer premises 520, service provider 560 may provide communication signals to gateway 530 via Ethernet interface 403A by a layer 2 virtual LAN address or IP address over the WAN. Gateway 530 may also be coupled to PC 528, telephone 526, and TV 524, in customer premises 520. In this way, service provider 560 provides Internet services for PC 528, telephone services to telephone 526, and television services to TV 524, via gateway 530 and Ethernet interface 403A of NTD 522.

Furthermore, NTD 522 may be coupled to another customer premises, such as customer premises 510. NTD 522 may be coupled to gateway 502 of customer premises 510 to create a separate LAN from the LAN of customer premises 520. Gateway 502 may further be coupled to PC 506 and telephone 504. In one embodiment, CPU 404 directs layer 2 virtual LAN or IP communication for a second communication interface of NTD 522, such as Ethernet interface 403B. In this way, a service provider, such as service provider 570 or 580 may provide one or more services to customer premises 510. For example, in one embodiment, service provider 580 provides Internet services to PC 506 of customer premises 510 by addressing gateway 502 using layer 2 virtual LAN address or IP address over Ethernet interface 403B over the WAN. Furthermore, service provider 580 may provide telephone services for telephone 504 by addressing gateway 502 using layer 2 virtual LAN address or IP address over Ethernet interface 403B over the WAN.

It is to be appreciated that NTD 522 may be used to interface a plurality of service providers to a plurality of LANs. In one embodiment, each separate LAN that the NTD 522 interfaces to is a separate customer premises, i.e., customer premises 510 includes one LAN coupled to NTD 522 via Ethernet interface 403B and customer premises 520 includes another LAN coupled to NTD 522 via Ethernet interface 403A. It is to be appreciated that customer premises 510 and 520 may be separate physical structures, i.e., separate dwellings, or alternatively customer premises 510 and 520 may be separate rooms within the same physical structure, e.g., separate apartments, offices, or stores within the same building.

Furthermore, NTD 522 can be used to create separate LANs, within the same customer premises. For example, in one embodiment, a user in customer premises 520 may desire to use service provider 560 for television and Internet services and service provider 570 for telephone services. To achieve this, telephone 526 (or a separate modem or gateway coupled to telephone 526) may be coupled to an Ethernet port 403 of NTD 522 other than Ethernet port 403A and 403B, where the separate Ethernet port is addressable via the WAN. In this way, NTD 522 may be used to create two separate virtual LANs within the same customer premises 520, where, for example, service provider 570 provides one service (e.g., telephone) to customer premises 520 via an Ethernet interface 403 of NTD 522 and service provider 560 provides another service or services (e.g., Internet and telephone) to customer premises 520 via a separate Ethernet interface 403 of NTD 522. To achieve this, telephone 526 (or a separate modem or gateway coupled to telephone 526) may be coupled to an Ethernet port 403 of NTD 522 other than Ethernet port 403A and 403B, where the separate Ethernet port is addressable via the WAN.

As described earlier, the NTD 522 may be used to interface a plurality of service providers to a plurality of LANs with each service provider's gateway serving the LAN connected to a single Ethernet port. A technician for the access network provider 540 may need to investigate the data performance of an Ethernet port, such as Ethernet port/interface 403 for a particular service provider or premises. To facilitate this functionality, in one embodiment, NTD 522 is configured to maintain a logical entity associated with each tangible network interface (e.g., Ethernet interface 403) which collects performance data for the tangible network interface and can be used to diagnose the tangible network interface. It is to be appreciated that, in one embodiment, the logical entity is maintained by CPU 404 of NTD 522 and the performance data collected by the logical entity is stored in memory 412 of NTD 522. To aide in the addressing of this logical entity, the CPU 404 creates a custom locally-administered MAC Address based on the global/universal media access control (MAC) address of the tangible network interface.

In one embodiment, the MAC address, also known as an Extended Unique Identifier-48 (EUI-48), for each Ethernet port/interface 403, is converted to a locally administered address, i.e., the universally/locally administered address bit is changed from a zero to a one to identify the address as a local address. CPU 404 is configured to identify each universal MAC address assigned to each Ethernet port/interface 403 and convert it to a locally-administered MAC address. This “local” MAC address of each Ethernet interface 403 may then be converted by CPU 404 for use in an IPv6 network by converting the 48-bit value of each address into a 64-bit value by inserting the string of bits FF:FE into the middle of each local MAC address for each Ethernet port/interface 403. This 64-bit value may then be used in an IPv6 unique local unicast address to reference a logical entity associated with the Ethernet port/interface 403 of NTD 522. Each 64-bit IPv6 address created by CPU 404 is based on a 48-bit globally-unique MAC Address, but it is possible the 64-bit value represented by this 64-bit address could also be generated in an IPv6 network which would result in two addressable entities having the same IPv6 address. Therefore, in one embodiment, the generated IPv6 address is used as a link local address that may terminate at the next IPv6 router, such as border routers 552, 554, or 556, or be routed within the IP Network of the ANP 540 as controlled by the ANP network administrator. It is to be appreciated that the above described process may also be used convert the MAC address of interface 500 to an IPv6 link local address. It is to be appreciated that any version of Internet protocol addressing developed after IPv6 may include similar characteristics, particularly if the later version includes some level of backward compatibility. As a result, aspects of the present disclosure may apply or may be adapted by one skilled in the art to be used with the later Internet protocol version.

In one embodiment, a technician may access web pages containing information only for the communications to and from a particular Ethernet port or other communication interface of NTD 522 by connecting a laptop to the desired interface, such as Ethernet port 403 of the NTD 522, opening a browser, and entering the generated IPv6 address as the HTTP address of the associated web pages. It is to be appreciated that the web pages containing information relating to the communication interfaces of NTD 522 may be hosted by CPU 404, or alternatively the web pages may be hosted by ANP. In one embodiment, CPU 404 is configured to recognize this HTTP address as the address for the logical entity associated with the Ethernet port and present the associated information in web page form to the browser. These web pages could also provide the ability to manage the ANP services provided at this Ethernet port 403, e.g. change performance parameters such as port data rate or perform diagnostics.

As an example of generating the locally-administered MAC address and IPv6 address of the logical entity associated with a tangible network interface (e.g., Ethernet interface/port 403), the NTD 522 may include three regular universal administered MAC addresses, (where each is an EUI-48 address):
Cable Modem RF interface 500—C4:27:95:7D:02:20
Ethernet interface 403A—C4:27:95:7D:02:2A
Ethernet interface 403B—C4:27:95:7D:02:2B
   The IPv6 link local address for Ethernet interface 403A is created by CPU 404 by converting the globally-unique MAC address C4:27:95:7D:02:2A of Ethernet interface 403A into a first locally administered LAN MAC address by changing the universal/local administered address bit of the globally-unique MAC address C4:27:95:7D:02:2A to a ‘1’. The universal/local administered address bit is the second-most least significant bit of the first octet/byte—which in this example when changed to a ‘1’ converts the EUI-48 value to C6:27:95:7D:02:2A. Then, CPU 404 converts this 48-bit address into a 64-bit address by inserting the hexadecimal value FF:FE in the middle of the locally administered MAC address to create a 64-bit address (a.k.a. EUI-64)—C6:27:95:FF:FE:7D:02:2A for Ethernet interface 403A. This 64-bit address may then be used by the ANP 540 as an IPv6 link local address FD00::C6:27:95:FF:FE:7D:02:2A for the logical entity associated with Ethernet interface 403A.

In this example, the IPv6 address the technician would enter as the URL in the browser would be http://FD00::C6:27:95:FF:FE:7D:02:2A. It is to be appreciated that a similar process may be repeated for Ethernet interface 403B, interface 500, and any other Ethernet interface 403 of NTD 522 to create a custom IPv6 address that can be addressed by the ANP 540.

Although the above-described example includes addressing the logical entity associated to a communication interface (e.g., interface 403) of NTD 522 via the communication interface associated with the logical entity, any IPv6 address created by CPU 404 to address a logical entity associated to a communication interface 403 of NTD 522 may also be addressed from the WAN via interface 500. For example, in one embodiment, CPU 404 of NTD 522 is configured such that CPU 404 can recognize if a downstream communication signal (received from the WAN via interface 500) includes an IPv6 address for an Ethernet interface 403 of NTD 522. In this way, when a downstream communication signal including an IPv6 address for the logical entity associated with Ethernet interface 403 is received via interface 500 of NTD 522 and provided to CPU 404, CPU 404 is configured to route the communication signal to the logical entity for Ethernet interface 403 corresponding to the IPv6 address in the received communication. For example, a signal including an IPv6 address for the logical entity for Ethernet interface 403A that is received by CPU 404 may be provided to the logical entity for Ethernet interface 403A. Similarly, a signal including an IPv6 address for the logical entity for Ethernet interface 403B that is received by CPU 404 may be provided to the logical entity for Ethernet interface 403B.

It is to be appreciated that the techniques described above to generate an IPv6 address for a logical entity associated with a communication interface of a network termination device, such as NTD 522, may be used to maintain many types of logical entities. For example, as stated above, the logical entity may be a web page including information relating to the ANP service provided to a communication interface. As another example, the logical entity may be used to perform layer 2 Connectivity Fault Management (CFM). CFM measurements are a means of ensuring an ANP, such as ANP 540, is meeting the Service Level Agreement with service providers (SPs) using the ANP's service, such as service providers 560, 570, and 580. CFM activities include, but are not limited to, A) measuring continuity from one point to another point, B) tracing the route an SP's packet may take through the ANP network, C) measuring frame/packet losses through the ANP network, D) measuring frame latency (delay) and jitter (timing variation) through the ANP network, and E) measuring data rate through the ANP network.

For example, in one embodiment, the logical entity for each communication interface 403 of NTD 522 may be a maintenance entity group (MEG) end point (MEP) or a maintenance entity group (MEG) intermediate point (MIP) associated with the communication interface. In this way, the MEP/MIP logical entity associated with a communication interface 403 of NTD 522 may be configured to gather data associated with the communication interface 403 the MEP/MIP logical entity is associated with and the MEP/MIP logical entity may be addressed using the IPv6 address generated for the MEP/MIP logical entity using the techniques described above. The MEP/MIP logical entity may then be commanded or configured using this addressability to retrieve information collected by the MEP/MIP logical entity, or alternatively, to reconfigure the MEP/MIP logical entity as desired. Although the CFM standards above are consistent with IEEE 802.1Q, the above described embodiments may be used for logical entities of other CFM standards, such as Service Activation Methodology and Performance Monitoring, both of which are in used in ITU Y.1564.

It is to be appreciated that when CPU 404 receives a communication signal including an IPv6 address for a logical entity associated with a communication interface 403 of NTD 522, CPU 404 is configured to take action based on the use-context of the logical entity of the IPv6 Address (or other

Internet protocol address) in the frame (layer 2) or packet (layer 3) of the communication signal. For example, if the generated IPv6 address is used within the HTTP context (i.e., the web page example described above) then CPU 404 displays the web page including the information relating the communication interface associated with the logical entity. If the logical entity is used within the context of CFM, then CPU 404 may analyze the packets of the received communication signal to determine what action to take for the logical maintenance entity (e.g., MEP, MIP, etc.). For example, CPU 404 is configured to read the CFM “OpCode” in the frame of the received communication signal, such as, but not limited to, “Continuity Check”, “Link Trace”, “Loop-Back”, “Link Trace Reply”, “Loop-Back Reply”, or “Alarm Indication”. The MEP logical entity initiates Continuity Check Messages, Loop-Back and Link Trace messages, responds to Loop-Back and Link Trace messages, and forwards messages to higher level maintenance entities. The MIP logical entity responds to Loop-Back and Link Trace messages, and forwards messages to higher level maintenance entities. When CPU 404 detects a CFM frame, CPU 404 may forward the CFM frame to both the MEP (if defined) and MIP (if defined) associated with the MAC address or the locally-administered MAC address for the Ethernet port 403 in the IPv6 packet.

It is to be appreciated that, in one embodiment, more than one logical entity may be associated to a single Ethernet port or interface 403 in accordance with the present disclosure. In this embodiment, when CPU 404 receives a communication signal including an Internet protocol address associated to an Ethernet port or interface 403, CPU 404 may determine which logical entity to provide the communication signal to based on the use-context of the logical entity of the Internet protocol address in the frame (layer 2) or packet (layer 3) (as described above). In other words, CPU 404 determines the intended use of a communication signal including an Internet protocol address associated to an Ethernet port or interface 403 (i.e., based on information in the packet or frame of the communication signal), and CPU 404 provides the communication signal to the proper logical entity associated with the Ethernet port or interface 403, based on the determined intended use. In this way, a single Internet protocol address (generated using the MAC address of an Ethernet port or interface 403, as described above) may be used to address one or more logical entities associated with a single Ethernet port or interface 403.

In one embodiment, the logical entity may be used to manage the throughput data rates of sub-classes of layer 2 frames within a VLAN served by a physical Ethernet port, such as Ethernet port 403. For example, a single VLAN may be configured to support up to 8 sub-classes of layer 2 frame traffic using the “PCP bits” (3 bits) in the layer 2 frame. For example, if a Service Provider (SP) has a Service Level Agreement (SLA) with the ANP to provide 100 Mbps to a SP's Small-Medium Business (SMB) customer served by NTD 522. The ANP provides a 100 Mbps VLAN circuit between the SP and the SMB. However, the SP may want to provide three “traffic class” (TC) levels within the SLA service: TC-1 (guaranteed bandwidth, low latency), TC-2 (guaranteed bandwidth at less than a specified latency), and TC-3 (remaining unused bandwidth at “best effort” quality). For example, the ANP may agree in the terms of the SLA that traffic of class TC-1 may be mapped to PCP value ‘5’, TC-2 may be mapped to PCP value ‘4’, and TC-3 may be mapped to PCP value ‘1’. The SP is responsible for tagging its layer 2 frames within the VLAN with the correct PCP value and the logical entity in NTD 522 is configured to manage the traffic flow to meet the SLA agreements.

In the above-described example, it is to be appreciated the CPU 404 is configured to maintain a logical entity associated with traffic class. The logical entity may measure the throughput or latency experienced by specific traffic class(es) at a single Ethernet interface or port 403. In this way, the separate logical entity associated with traffic class that measures the throughput or latency experienced by each corresponding traffic class at a single Ethernet interface 403 may be addressable via an Ethernet interface 403 or the WAN (via interface 500). When a layer 2 frame for the logical entity associated with traffic class (i.e., including one of the PCP values described above) is received, CPU 404 may provide the layer 2 frame to the logical entity associated with traffic class. The layer 2 frame may include a request by a SP for information gathered by the logical entity associated with traffic class. CPU 404 may determine the specific traffic class level relating to the received communication signal by reading the PCP value in the communication signal. For example, CPU 404 may determine that a communication signal including a PCP value of “1” relates to TC-1.

It is also to be appreciated that, in one embodiment, there may be a separate logical entity for each traffic class level. In this embodiment, when CPU 404 receives a communication signal including the Internet protocol address generated using the MAC address of an Ethernet port or interface 403, CPU 404 may determine based on the PCP value in the communication signal, which logical entity to provide the communication signal to. For example, if the communication signal includes PCP value of “1”, CPU 404 may provide the communication signal to the logical entity associated with TC-1.

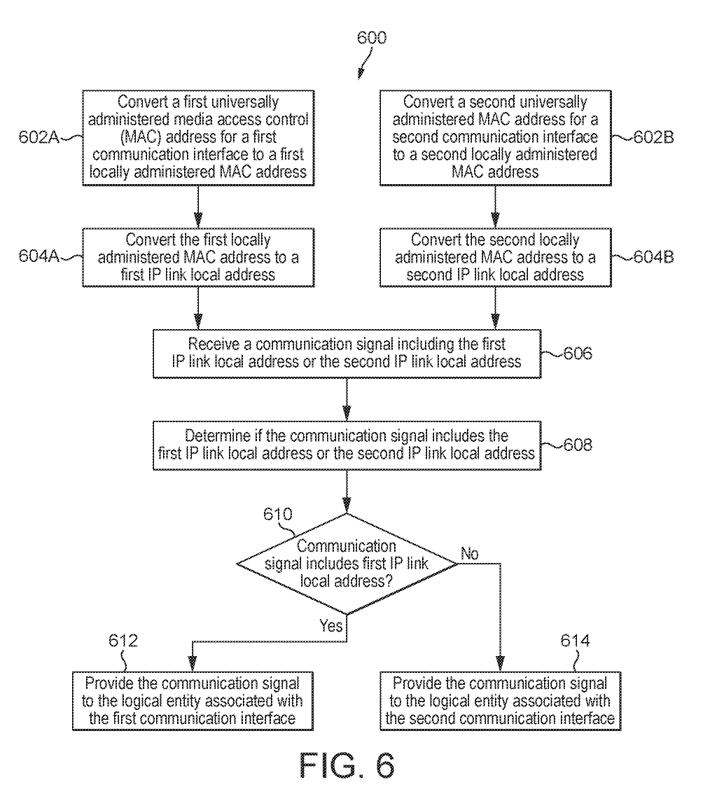

Referring to FIG. 6, a flowchart including a method 600 for creating one or more Internet protocol addresses for logical entities associated with one or more communication interfaces of an NTD, such as NTD 522, and receiving communication signals addressed to a logical entity associated with a communication interface of an NTD is shown in accordance with the present disclosure.

In step 602A, CPU 404 converts a first universally administered MAC address associated with a first communication interface (e.g., Ethernet interface 403A) to a first locally administered MAC address. In step 602B, CPU 404 converts a second universally administered MAC address associated with a second communication interface (e.g., Ethernet interface 403B) to a second locally administered MAC address. It is to be appreciated that, in one embodiment, CPU 404 may convert the first and second universally administered MAC addresses to a first and second locally administered MAC address by changing the universally/locally administered address bit of each of the first and second universally administered MAC addresses from a zero to a one.

In step 604A, CPU 404 converts the first locally administered MAC address to a first IP address. In step 604B, CPU 404 converts the second locally administered MAC address to a second IP link local address. In one embodiment, the CPU 404 may convert the first and second locally administered MAC addresses to first and second Internet protocol link local addresses by inserting the hexadecimal value FF:FE in the middle of each locally administered MAC address. In step 606, CPU 404 receives a communication signal including the first IP link local address or the second IP link local address. It is to be appreciated that CPU 404 may receive the communication signal in step 606 from the WAN via communication interface 500, or alternatively, from a communication interface 403 coupled to a LAN (e.g., communication interfaces 403A and 403B). In step 608, CPU 404 determines if the communication signal includes the first Internet protocol link local address or the second Internet protocol link local address. If CPU 404 determines that the communication signal includes the first Internet protocol link local address, in step 610, CPU 612 provides the communication signal to the logical entity associated with the first communication interface (e.g., Ethernet interface 403A), in step 612. If CPU 404 determines that the communication signal includes the second Internet protocol link local address, in step 610, CPU 612 provides the communication signal to the logical entity associated with the second communication interface (e.g., Ethernet interface 403B), in step 612.

As described above, the embodiments of the present disclosure enable a technician for an ANP, such as ANP 540, to access information and investigate data performance of a communication interface of an NTD, such as NTD 522, by accessing a logical entity, such as a web server, associated with a communication interface of the NTD. In one embodiment of the present disclosure, the technician may access web pages on the web server containing information only for the communications to and from a particular Ethernet port or other communication interface of NTD 522 by connecting a laptop to the desired interface, such as Ethernet port 403A of the NTD 522, opening a browser, and entering the generated Internet protocol address (i.e., from steps 602 and 604 described above) for the logical entity (i.e., the web server containing the web pages) as the HTTP address of the associated web pages.

One approach for simplifying addressability of the logical entity involves converting a long string of hexadecimal numbers identifying the address into a simple character string. Such an approach is used with respect to typing, for example, “www.google.com”, and converting this string (using Domain Name Server functionality included in a device such as NTD 522) into an IPv4 address 216.58.216.4 or similar IPv6 address.

However, the mapping may not be correct for the address of the logical entity if the actual communication interface or Ethernet port 403 that is being used for communication onto the LAN is not also identified noting that the NTD 522 actually includes a plurality of MAC addresses because it has a plurality of Ethernet ports 403. Typically, an ANP's communication networks are not freely accessed and so requesting an address other than the desired address may result in a communication error. To address this issue, in one embodiment, when CPU 404 receives a character string representing a Uniform Resource Locator (URL) request for a web page associated with a communication interface of NTD 522, CPU 404 of NTD 522 is configured to determine the port or interface 403 from which the address request is made and take this character string along with the determined port and select the appropriate locally administered MAC address and corresponding Internet protocol link local address for the communication interface. It is to be appreciated that the Internet protocol link local address is generated as described above in reference to FIG. 6.

As an example of the operation of the simple address identification mechanism, consider an NTD 522 with two Ethernet ports/interfaces 403A and 403B. Ethernet port 403A is physically accessed by, or connected into by, a technician using a laptop who wishes to check traffic activity between the NTD 522 and an ANP's (e.g., ANP 540) home center or headend, e.g. the CMTS 542, for the premises served by Ethernet port 403A. Once the connection is made at the port 403A, the NTD 522 identifies the data connection by using the MAC address of the laptop network interface to generate an Internet protocol link local address for the laptop and assigns it to the laptop. The NTD 522 receives a command from the technician using an assigned string, for example, “http://tch_interface”, as the URL in the technician's browser's address bar. It is important to note that this string is a generic assigned string for access to the associated logical entity using any NTD 522, however, the teachings of the present disclosure may be used with any desired string associated with a logical entity.

It is to be appreciated that upon receiving the string, CPU 404 examines the string to determine if it matches the assigned string (e.g., http://tch_interface) to obtain the web pages associated with the communication interface. If the user inputted string matches the assigned string, then CPU 404 modifies the assigned string to include information to identify the physical port used by the technician. In one embodiment, the port information may be something as simple as a port number, such as ‘A’ or ‘B’, or it may be the MAC address associated with the physical port. The combination of the assigned string and port identification is enough information to select the web pages dedicated for that port. For example, when CPU 404 receives a string “tch_interface” from an Ethernet interface 403A, CPU 404 may determine that the received string matches the assigned string, determine the Ethernet interface 403 that the string was received from, and modify the received string to be “tch_interface_A”, where the “A” indicates that the string was received from Ethernet interface 403A.

If the NTD 522 has a local web server function, then CPU 404 performs an initial Domain Name Server (DNS) lookup of the modified assigned string (e.g., “tch_interface_A”). If the modified assigned string is found, CPU 404 resolves the modified assigned string to the generated Internet protocol address for the proper logical entity to provide the web pages for the communication interface 403 the user inputted string was received from. If the modified assigned string cannot be resolved (i.e., is unknown), then the local web server function may reply with the standard HTTP error message for web page not found.

If the user inputted string does not match the assigned string, then CPU 404 may send the original user inputted string to an external DNS (i.e., on the WAN) for IP address resolution. In this way, if a string that is not intended to request a logical entity associated with a communication interface of NTD 522 is received by CPU 404, such as “http://google.com”, CPU 404 may send the request for “http://google.com” to an external DNS on the WAN.

If the NTD 522 does not have a local web server function and relies on a web server provided by the ANP, then the ANP may need enough information to uniquely select the appropriate web pages for the physical communication port 403 used on the specific NTD 522. In this case, there are several unique tuples of information that could identify the correct web pages for physical port 403: A) the assigned string coupled with the MAC Address of the physical port (this MAC address can be obtained from the Source MAC Address of the layer 2 frame), B) the assigned string coupled with the port number and the WAN MAC Address of the NTD 522, or C) the generated Internet protocol address as the URL to identify the web logical entity associated with the physical port 403. In an exemplary case, the CPU 404 provides the generated Internet protocol link local address to an external DNS in the ANP and the ANP provides the web pages dedicated to the NTD's communication interface by performing a DNS function on the generated Internet protocol link local address to provide the web pages associated with the communication port to the NTD 522 for the NTD 522 to pass to the communication port 403.

In one embodiment, CPU 404 receives a string (e.g., “tch_interface”) associated with a logical entity. Based on the MAC addresses for the NTD 522 and the determination by CPU 404 of the specific port 403 that the string is received from, the CPU 404 maps the received string to the Internet protocol link local address for the logical entity (i.e., the web server containing the web pages described above) associated to the specific port 403. It is to be appreciated that the Internet protocol link local address is generated as described above in reference to FIG. 6 and may be stored in memory 412, where CPU 404 is configured to retrieve the Internet protocol link local address from the memory 412 after the determination is made as to what port 403 the string was received from. Furthermore, it is to be appreciated that, in one embodiment, CPU 404 may generate the Internet protocol link local address upon receiving the string. For example, after CPU 404 determines the specific port 403 that the string was received from, CPU 404 converts this string into the MAC address for Ethernet port 403A of CPU 404 of NTD 522, converts the MAC address to a 64-bit locally administered address, and uses the 64-bit locally administered address to create an Internet protocol link local address. In either case, after CPU 404 maps the received string to the Internet protocol link local address, CPU 404 sends out the Internet protocol link local address to the logical entity (i.e., the web server) associated with the port or interface 403 to request the web page. It is to be appreciated that the logical entity or web server may be hosted by CPU 404 or alternatively the logical entity may be hosted by ANP 540.

As an example using an IPv6 address, when CPU 404 receives the string “http://tch_interface” from Ethernet port 403A, CPU 404 maps the string to: “http://FD00::D427:95FF:FE70:022A”, which is the IPv6 address for the logical entity associated with Ethernet port 403A. It is to be appreciated that the end portion of this string is the portion that specifically identifies Ethernet port 403A, where the NTD 522 Ethernet port 403A MAC address ends in 022A and Ethernet port 403B MAC address ends in 022B. The string “http://FD00::D427:95FF:FE70:022A” is then sent to the logical entity by CPU 404. In this way, a technician can use a simple assigned string entered into a web browser to access a logical entity associated with a communication interface 403 of NTD 522 without knowledge of the specific IPv6 address for the logical entity.

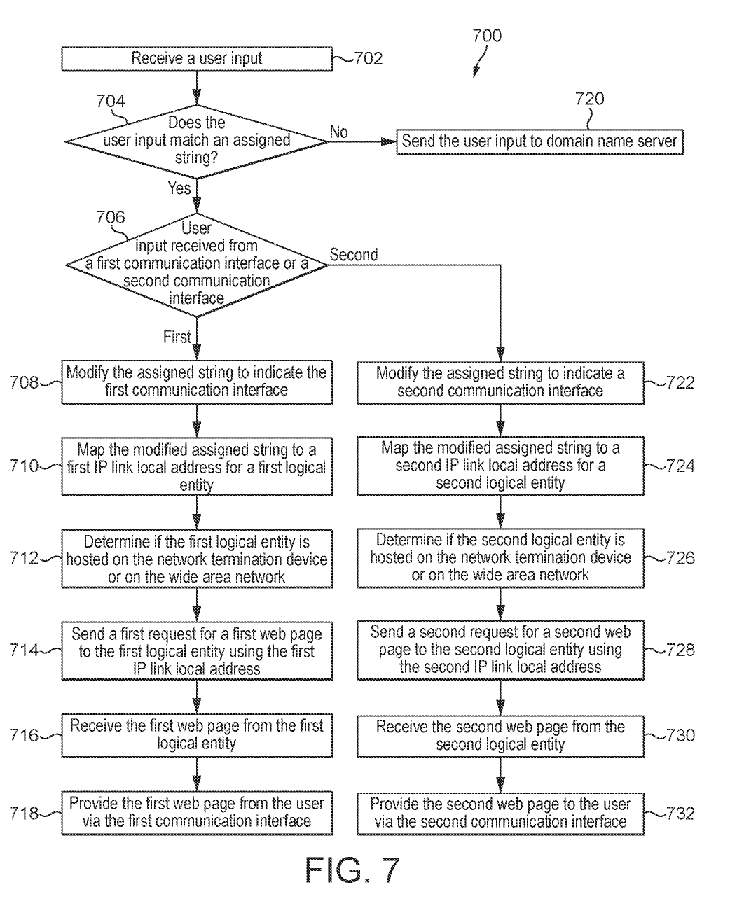

Referring to FIG. 7, a flowchart of a method 700 for requesting a web page from a logical entity associated with a communication interface is shown in accordance with an embodiment of the present disclosure. In step 702, NTD 522 receives a user input, where the user input represents an indirect identification of a URL. As stated above, in one embodiment, the user input may be an attempt from a technician to access a web page associated with a logical entity, where the logical entity is associated with a communication interface of an NTD, such as NTD 522. In step 704, CPU 404 determines if the user input matches an assigned string (e.g., “tch_interface”). If CPU 404 determines that the user input does not match the assigned string, in step 704, CPU 404 may send the user input to the domain name sever, in step 720. If CPU 404 determines that the user input matches the assigned string, in step 704, the method 700 proceeds to step 706.

In step 706, CPU 404 determines if the user input was received from a first communication interface (e.g., Ethernet interface 403A) or a second communication interface (e.g., Ethernet interface 403B) using the physical port identification. If CPU 404 determines that the user input was received from the first communication interface (e.g., Ethernet interface 403A), in step 706, CPU 404 modifies the assigned string to indicate the first communication interface, in step 708. For example, if the received user input is “tch_interface”, CPU 404 modifies the received string to “tch_interface_A”, where the “A” indicates that the string was received from Ethernet interface 403A. Then, CPU 404 maps the modified assigned string to the first Internet protocol address (as described above) for a first logical entity associated with the first communication interface, in step 710.

As stated above, the first logical entity may be hosted on a web server maintained by CPU 404 of NTD 522, or alternatively, the first logical entity may be hosted on web server maintained by ANP 540 in the WAN. In one embodiment, CPU 404 is configured to determine if the first logical entity is hosted on NTD 522 or if the first logical entity is hosted by ANP 540 in the WAN, in step 712. Based on the determination in step 712, CPU 404 sends a first request for the first web page to the first logical entity using the first Internet protocol address for the first logical entity, in step 714. If CPU 404 determines that the first logical entity is hosted on NTD 522, in step 712, CPU 404 sends the first request for the first web page to the web server on NTD 522 that hosts the first logical entity, in step 714. If CPU 404 determines that the first logical entity is hosted on a web server in the WAN by ANP 540, in step 712, CPU 404 sends the first request for the first web page to the web server in the WAN hosted by ANP 540 via a third communication interface (e.g., interface 500), in step 714.

After the first logical entity receives the first request for the first web page, the first logical entity sends the first web page to CPU 404. In step 716, CPU 404 receives the first web page from the first logical entity. After CPU 404 receives the first web page from the first logical entity, CPU 404 then provides the first web page to the user via the first communication interface (e.g., the web page is provided to the technician's laptop that is connected to Ethernet interface 403A), in step 718.

If CPU 404 determines that the user input was received from the second communication interface (e.g., Ethernet interface 403B), in step 706, CPU 404 modifies the assigned string to indicate the second communication interface, in step 722. For example, if the received user input is “tch_interface”, CPU 404 modifies the received string to “tch_interface_B”, where the “B” indicates that the string was received from Ethernet interface 403B. Then, CPU 404 maps the modified assigned string to the second Internet protocol address for the second logical entity associated with the second communication interface, in step 724.

As stated above, the second logical entity may be hosted on a web server maintained by CPU 404 of NTD 522, or alternatively, the second logical entity may be hosted on web server maintained by ANP 540 in the WAN. In one embodiment, CPU 404 is configured to determine if the second logical entity is hosted on NTD 522 or if the second logical entity is hosted by ANP 540 in the WAN. Based on the determination in step 726, CPU 404 sends a second request for the second web page to the second logical entity using the second Internet protocol address for the second logical entity, in step 728. If CPU 404 determines that second the logical entity is hosted on NTD 522, in step 726, CPU 404 sends the second request for the second web page to the web server on NTD 522 that hosts the second logical entity, in step 728. If CPU 404 determines that the second logical entity is hosted on a web server in the WAN by ANP 540, in step 726, CPU 404 may send the second request for the second web page to the web server in the WAN hosted by ANP 540 via a third communication interface (e.g., interface 500), in step 728.

After the second logical entity receives the second request for the second web page, the second logical entity may send the second web page to CPU 404. In step 730, CPU 404 receives the second web page from the second logical entity. After CPU 404 receives the second web page from the second logical entity, CPU 404 then provides the second web page to the user via the second communication interface (e.g., the web page is provided to the technician's laptop that is connected to Ethernet interface 403B), in step 732.

It is to be appreciated that although the steps of method 700 are described in relation to an apparatus (e.g., NTD 522) including two communication interfaces, method 700 may be used with an apparatus including any number of communication interfaces, where each communication interface has a uniquely addressable Internet protocol address.

In one embodiment of the present disclosure a method is provided including receiving an input from a user at a device, determining if the input was received through a first communication interface coupled to a first local area network, and sending a first request for a first webpage to a first logical entity associated with the first communication interface if it is determined that the input was received through the first communication interface, the first webpage including information associated with the first communication interface.

In another embodiment of the present disclosure, the method includes determining if the user input matches an assigned string and modifying the user input to indicate the first communication interface if it is determined that the user input matches the assigned string.

In another embodiment of the present disclosure, the method includes wherein the first communication interface includes a first media access control address and the method further includes generating the first Internet protocol address using the first media access control address.

In another embodiment of the present disclosure, the method includes wherein the first Internet protocol address is compliant with IPv6 and wherein the generating further includes converting the first media access control address from a universally administered media access control address to a locally administered media access control address and inserting a string of bytes into the locally administered media access control address to generate the first Internet protocol address.

In another embodiment of the present disclosure, the method includes receiving the first webpage from the first logical entity and providing the first webpage to the user via the first communication interface.

In another embodiment of the present disclosure, the method includes wherein the determining further includes determining if the input was received through a second communication interface coupled to a second local area network and sending a second request for a second webpage to a second logical entity associated with the second communication interface if it is determined that the input was received from the second communication interface.

In another embodiment of the present disclosure, the method includes receiving the second webpage from the second logical entity and providing the second webpage to the user via the second communication interface.

In another embodiment of the present disclosure, the method includes wherein first communication interface is coupled to a second communication interface, wherein the second communication interface is coupled to a wide area network.

In another embodiment of the present disclosure, the method includes determining if the first logical entity is hosted on a webserver in the device or on a webserver in the wide area network, wherein the sending includes sending the first request to the webserver in the device if it is determined that the first logical entity is hosted on the webserver in the device and sending the first request to the webserver in the wide area network if it is determined that the first logical entity is hosted on the webserver in the wide area network.

In another embodiment of the present disclosure, an apparatus is provided including a first communication interface coupled to a first local area network; and a processor coupled to the first communication interface, wherein the processor receives an input from a user, determines if the input was received through the first communication interface, and sends a first request for a first webpage to a first logical entity associated with the first communication interface if it is determined that the input was received through the first communication interface, the first webpage including information associated with the first communication interface.

In another embodiment of the present disclosure, the apparatus includes wherein the processor determines if the user input matches an assigned string and modifies the user input to indicate the first communication interface if the processor determines that the user input matches the assigned string.

In another embodiment of the present disclosure, the apparatus includes wherein the processor maps the user input to a first Internet Protocol address for the first logical entity if it is determined that the input was received through the first communication interface, wherein the processor sends the first request using the first Internet protocol address.

In another embodiment of the present disclosure, the apparatus includes wherein the first communication interface includes a first media access control address and the processor generates the first Internet protocol address using the first media access control address.

In another embodiment of the present disclosure, the apparatus includes wherein the first Internet protocol address is compliant with IPv6 and wherein the processor converts the first media access control address from a universally administered media access control address to a locally administered media access control address and inserts a string of bytes into the locally administered media access control address to generate the first Internet protocol address.

In another embodiment of the present disclosure, the apparatus includes wherein the processor receives the first webpage from the first logical entity and provides the first webpage to the user via the first communication interface.

In another embodiment of the present disclosure, the apparatus includes wherein the processor determines if the input was received through a second communication interface coupled to a second local area network and sends a second request for a second webpage to a second logical entity associated with the second communication interface if it is determined that the input was received from the second communication interface.

In another embodiment of the present disclosure, the apparatus includes wherein the processor receives the second webpage from the second logical entity and provides the second webpage to the user via the second communication interface.

In another embodiment of the present disclosure, the apparatus includes wherein the first communication interface and the second communication interface are Ethernet ports.

In another embodiment of the present disclosure, the apparatus includes wherein first communication interface is coupled to a second communication interface, wherein the second communication interface is coupled to a wide area network.

In another embodiment of the present disclosure, the apparatus includes wherein the processor determines if the first logical entity is hosted on a webserver in the processor or on a webserver in the wide area network, and wherein the processor sends the first request to the webserver in the processor if it is determined that the first logical entity is hosted on the webserver in the processor and sends the first request to the webserver in the wide area network if it is determined that the first logical entity is hosted on the webserver in the wide area network.

It is to be appreciated that the various features shown and described are interchangeable. Unless otherwise indicated, a feature shown in one embodiment may be incorporated into another embodiment. Further, the features described in the various embodiments may be combined or separated unless otherwise indicated as inseparable or not combinable.

Although embodiments which incorporate the teachings of the present disclosure have been shown and described in detail herein, those skilled in the art can readily devise many other varied embodiments that still incorporate these teachings. Having described preferred embodiments of a system and method for providing addressability to a device in a network, it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method comprising:
receiving an input from a user at a device, the input including a request for a webpage;
determining if the user input was received through a first communication interface coupled to a first local area network or a second communication interface;
determining if the webpage request matches an assigned string;
modifying the webpage request if the webpage request matches the assigned string, wherein the processor modifies the webpage request to generate a first modified webpage request that includes information associated with the first communication interface if the user input was received through the first communication interface and generates a second modified webpage request that includes information associated with the second communication interface if the user input was received through the second communication interface; and
sending a first request for the first modified webpage to a first logical entity associated with the first communication interface if it is determined that the input was received through the first communication interface; and
sending a second request for the second modified webpage to a second logical entity associated with the second communication interface if it is determined that the input was received through the second communication interface.

2. (canceled)

3. The method of claim 1, further comprising mapping the user input to a first Internet Protocol address for the first logical entity if it is determined that the input was received through the first communication interface, wherein the sending of the first request further includes sending the first request using the first Internet protocol address.

4. The method of claim 3, wherein the first communication interface includes a first media access control address and the method further comprises generating the first Internet protocol address using the first media access control address.

5. The method of claim 4, wherein the first Internet protocol address is compliant with IPv6 and the generating further includes converting the first media access control address from a universally administered media access control address to a locally administered media access control address and inserting a string of bytes into the locally administered media access control address to generate the first Internet protocol address.

6. The method of claim 1, further comprising receiving the first modified webpage from the first logical entity and providing the first webpage to the user via the first communication interface.

7. (canceled)

8. The method of claim 1, further comprising receiving the second modified webpage from the second logical entity and providing the second webpage to the user via the second communication interface.

9. The method of claim 1, wherein at least one of the first communication interface and the second communication interface are Ethernet ports.

10. The method of claim 1, wherein first communication interface is coupled to a third communication interface, wherein the third communication interface is coupled to a wide area network.

11. The method of claim 10, further comprising determining if the first logical entity is hosted on a webserver in the device or on a webserver in the wide area network, wherein the sending includes sending the first request to the webserver in the device if it is determined that the first logical entity is hosted on the webserver in the device and sending the first request to the webserver in the wide area network if it is determined that the first logical entity is hosted on the webserver in the wide area network.

12. An apparatus comprising:
a first communication interface coupled to a first local area network;
a second communication interface coupled to a second local area network; and
a processor coupled to the first communication interface and the second communication interface, wherein the processor:
receives an input from a user, the input including a request for a webpage;
determines if the user input was received through the first communication interface or the second communication interface;
determines if the webpage request matches an assigned string;
modifies the webpage request if the webpage request matches the assigned string, wherein the processor modifies the webpage request to generate a first modified webpage request that includes information associated with the first communication interface if the user input was received through the first communication interface and generates a second modified webpage request that includes information associated with the second communication interface if the user input was received through the second communication interface;
sends a first request for the first modified webpage to a first logical entity associated with the first communication interface if it is determined that the input was received through the first communication interface; and
sends a second request for the second modified webpage to a second logical entity associated with the second communication interface if it is determined that the input was received through the second communication interface.

13. (canceled)

14. The apparatus of claim 12, wherein the processor maps the user input to a first Internet Protocol address for the first logical entity if it is determined that the input was received through the first communication interface, wherein the processor sends the first request using the first Internet protocol address.

15. The apparatus of claim 14, wherein the first communication interface includes a first media access control address and the processor generates the first Internet protocol address using the first media access control address.

16. The apparatus of claim 15, wherein the first Internet protocol address is compliant with IPv6 and wherein the processor converts the first media access control address from a universally administered media access control address to a locally administered media access control address and inserts a string of bytes into the locally administered media access control address to generate the first IPv6 address.

17. The apparatus of claim 12, wherein the processor receives the first modified webpage from the first logical entity and provides the first modified webpage to the user via the first communication interface.

18. (canceled)

19. The apparatus of claim 12, wherein the processor receives the second modified webpage from the second logical entity and provides the second modified webpage to the user via the second communication interface.

20. The apparatus of claim 12, wherein at least one of the first communication interface and the second communication interface are Ethernet ports.

21. The apparatus of claim 12, wherein first communication interface is coupled to a third communication interface, wherein the third communication interface is coupled to a wide area network.

22. The apparatus of claim 21, wherein the processor determines if the first logical entity is hosted on a webserver in the processor or on a webserver in the wide area network, and wherein the processor sends the first request to the webserver in the processor if it is determined that the first logical entity is hosted on the webserver in the processor and sends the first request to the webserver in the wide area network if it is determined that the first logical entity is hosted on the webserver in the wide area network.
